(19) United States
(12) Patent Application Publication
(10) Pub. No.: US 2011/0248027 A1
(43) Pub. Date: Oct. 13, 2011

(54) Heating coil

(75) Inventors: Lien-Hsing Chen, Taichung County (TW); Chih-Chi Chang, Taichung County (TW); Hui-Hung Hsiang, Taichung County (TW)

(73) Assignee: POWER MATE TECHNOLOGY CO., LTD., TAICHUNG (TW)

(21) Appl. No.: 12/801,410

(22) Filed: Jun. 8, 2010

(30) Foreign Application Priority Data
Apr. 8, 2010 (TW) 99206198

(51) Int. Cl. H05B 6/36

(52) U.S. Cl. 219/672

(57) ABSTRACT

A heating coil includes at least one winding having a plurality of approach portions. Each of the approach portions is close to a workpiece surrounded by the winding. The winding defines two electrodes at two ends thereof for electric connection with a high-frequency power source. Accordingly, the workpiece can be heated more equably than that of the prior art.

### BACKGROUND OF THE INVENTION

1. Field of the Invention

The present invention relates generally to a heating coil, and more particularly, to a heating coil for high-frequency heating.

2. Description of the Related Art

As the high-frequency heating technology continuously makes progress, its application become wider. For example, while it is intended to apply the high-frequency heating to a metallic workpiece, an operator can put the workpiece into a heating coil and then make the heating coil be connected with a high-frequency power source, whereby the surface of the metallic workpiece is heated by induction to reach the temperature that the user needs. The high-frequency heating has the features of rapid heating, higher energy density than the general heating, no flame, being primarily applied to soldering and metallic surface hardening.

Because the high-frequency heating heats the workpiece by induction via the heating coil, the geometric shape of the heating coil is crucial to whether the workpiece is heated equably. However, the existing heating coils still need improvement on the inequable heating of the workpiece. Referring to FIG. 10, taking heating a quadrangular workpiece 81 as an example, the heating coil 82 is quadrangular, corresponding to the workpiece 81 in shape. The corners of the workpiece 81 each are close to two adjacent sides of the heating coil to be heated by induction, such that the heightened temperature of each corner is higher than that of the midsection of the workpiece 81, however, it is unfavorable to the soldering in need of precise control of the temperature of the workpiece 81 in such a way that some parts of the workpiece 81 are subject to imperfect soldering.

### SUMMARY OF THE INVENTION

The primary objective of the present invention is to provide a heating coil, which a workpiece can be equably heated.

The foregoing objective of the present invention is attained by the heating coil includes at least one winding having a plurality of approach portions. Each of the approach portions is close to a workpiece surrounded by the winding. The winding defines two electrodes at two ends thereof for electric connection with a high-frequency power source.

### BRIEF DESCRIPTION OF THE DRAWINGS

FIG. 1 is a perspective view of a first preferred embodiment of the present invention.

FIG. 2 is a top view of the first preferred embodiment of the present invention.

FIG. 3 is a schematic view of the first preferred embodiment of the present invention, illustrating that the heating coil is heating a workpiece.

FIG. 4 is a perspective view of a second preferred embodiment of the present invention.

FIG. 5 is a top view of the second preferred embodiment of the present invention.

FIG. 6 is a schematic view of the second preferred embodiment of the present invention, illustrating that the heating coil is heating the workpiece.

FIG. 7 is a perspective view of a third preferred embodiment of the present invention.

FIG. 8 is a top view of the third preferred embodiment of the present invention.

FIG. 9 is a schematic view of the third preferred embodiment of the present invention, illustrating that the heating coil is heating the workpiece.

FIG. 10 is a schematic view of a conventional heating coil, which is heating a workpiece.

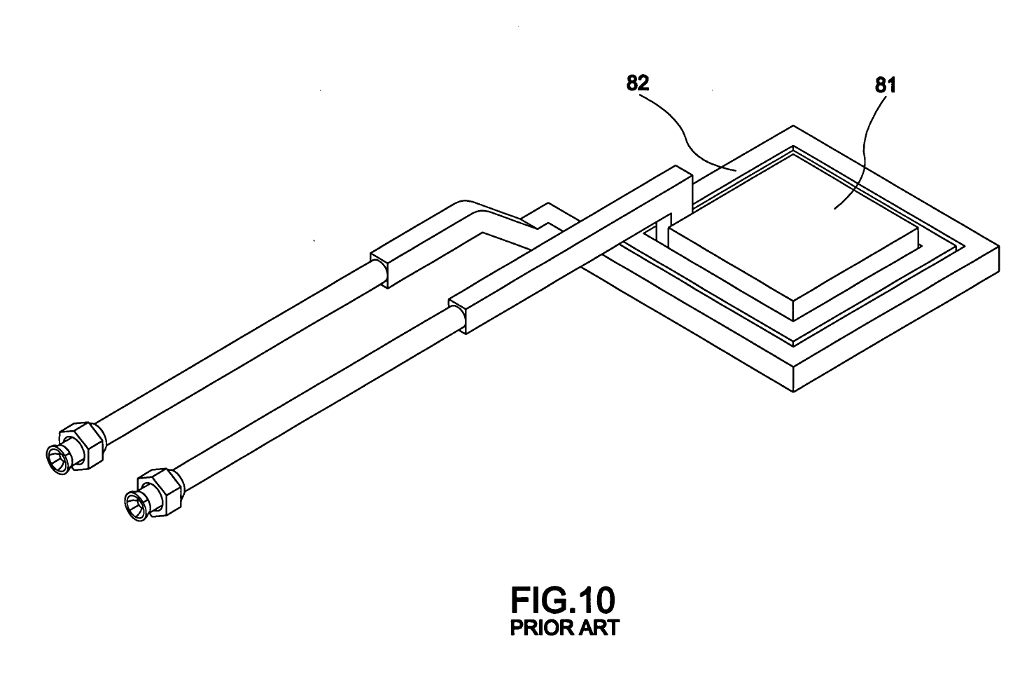

### DETAILED DESCRIPTION OF PREFERRED EMBODIMENTS

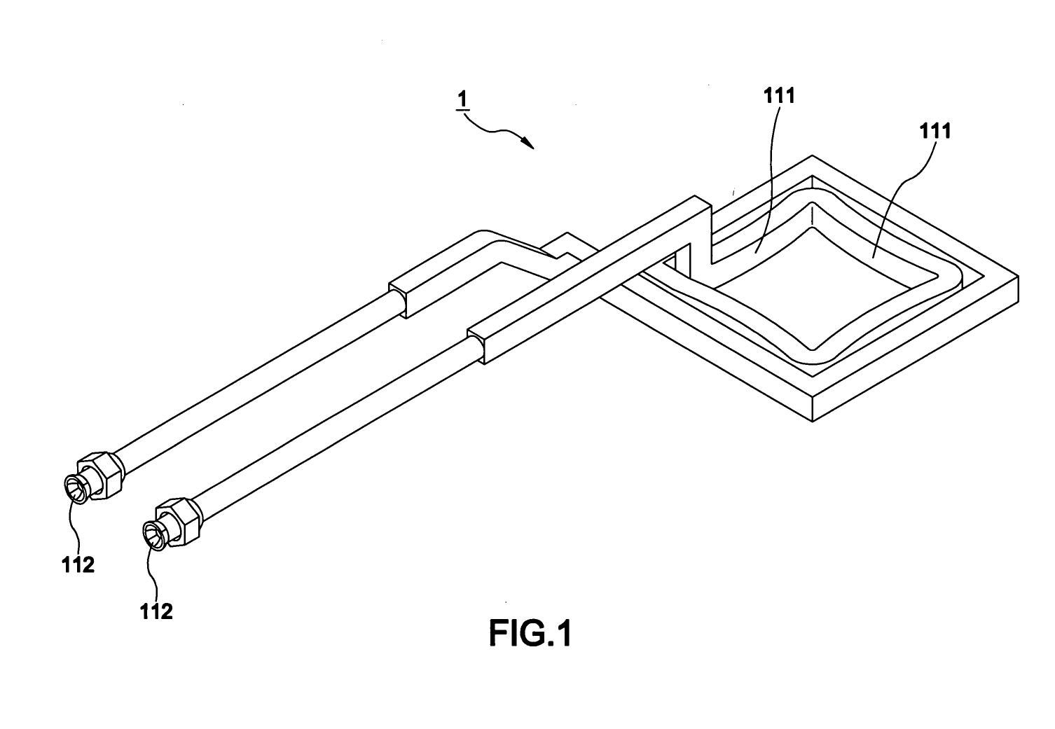

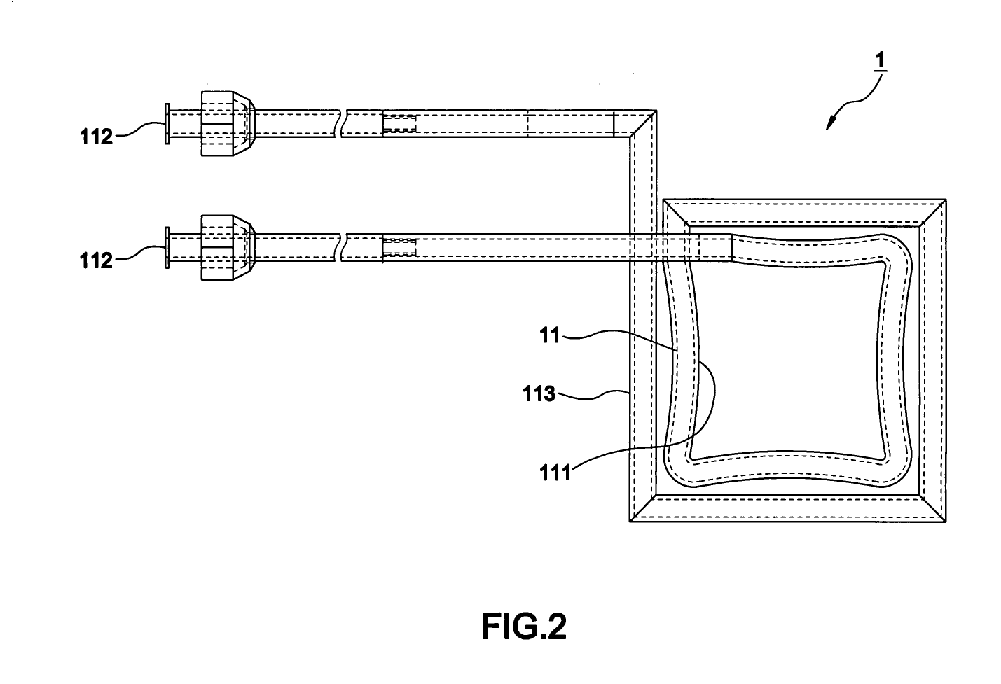

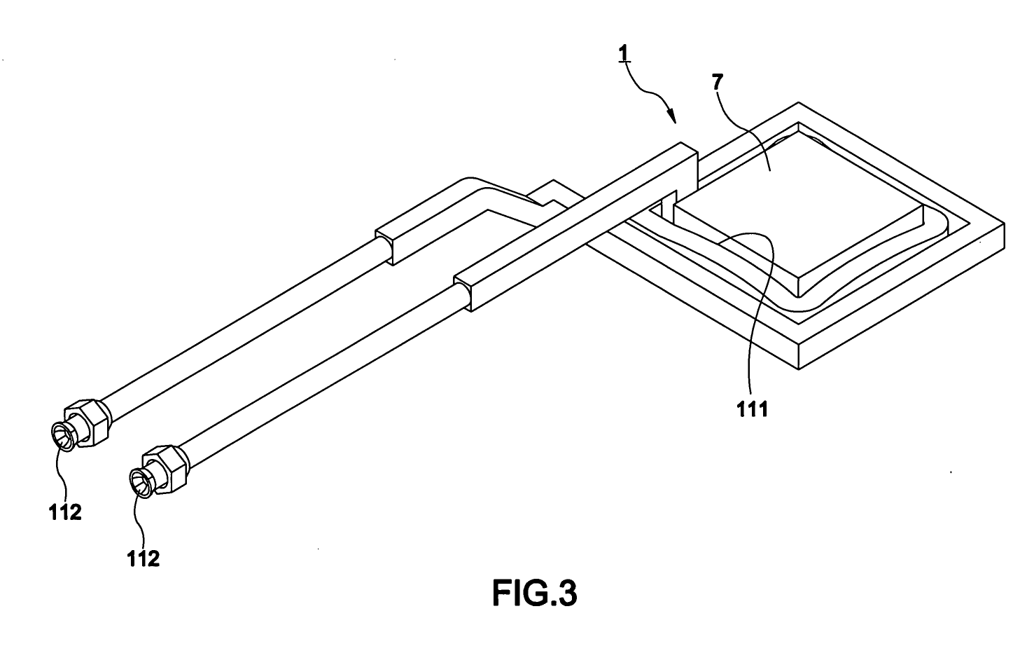

Referring to FIGS. 1-2, a heating coil 1 constructed according to a first preferred embodiment of the present invention is composed of a quadrangular winding 11. The winding 11 includes four approach portions 111 close to a workpiece 7 (FIG. 3) surrounded by the winding 11, and two electrodes 112 formed at two ends thereof for electric connection with a high-frequency power source. Each two of the approach portions 111 are opposite to each other. It is to be noted that the winding 11 is quadrangular for heating the workpiece 7. The electrodes 112 are parallel to each other for convenient connection with the high-frequency power source. A protective cover 113 encases the winding 11 for insulation and preventing the winding 11 from short circuit.

Referring to FIG. 3, while it is intended to operate the heating coil 1 of the present invention, a user can fasten the workpiece 7 having a to-be-soldered part (not shown); next, the user can fit the heating coil 1 onto the to-be-soldered part of the workpiece 7, and then connect the high-frequency power source to the electrodes 112 for providing the heating coil 1 with required energy for heating the workpiece 7 by induction. In the meantime, the approach portions 111 are closer to the workpiece 7 than the four corners of the workpiece 7 to further strengthen the induction heating and to heighten the temperature of the midsection of the workpiece 7, such that the temperature of the workpiece 7 at the corners and midsection is equable.

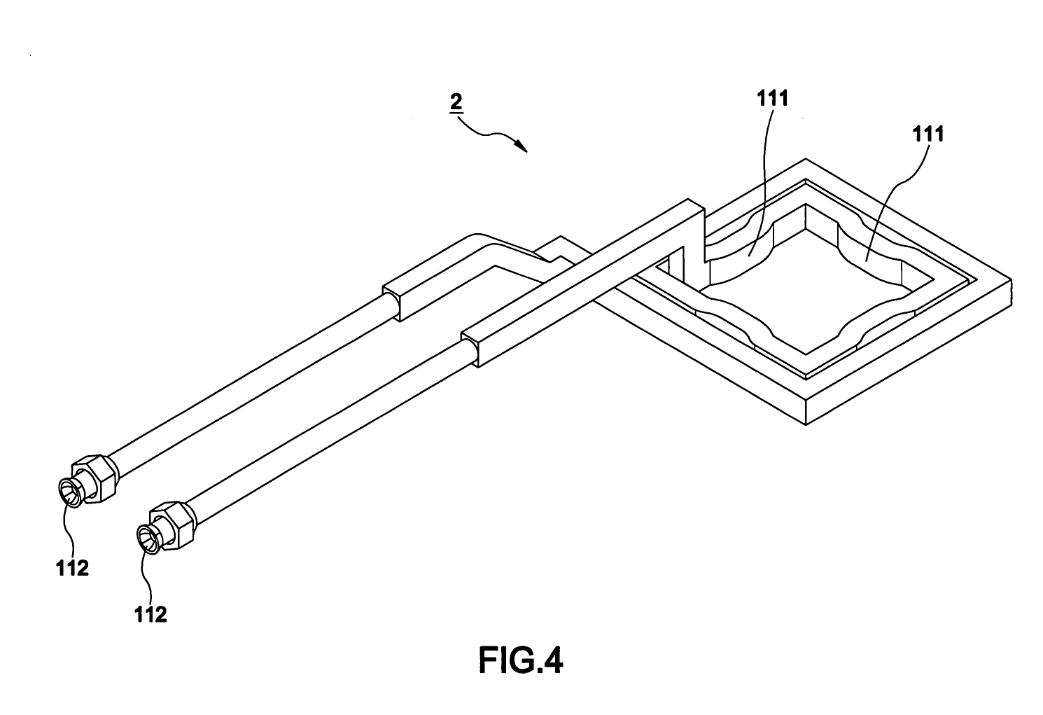

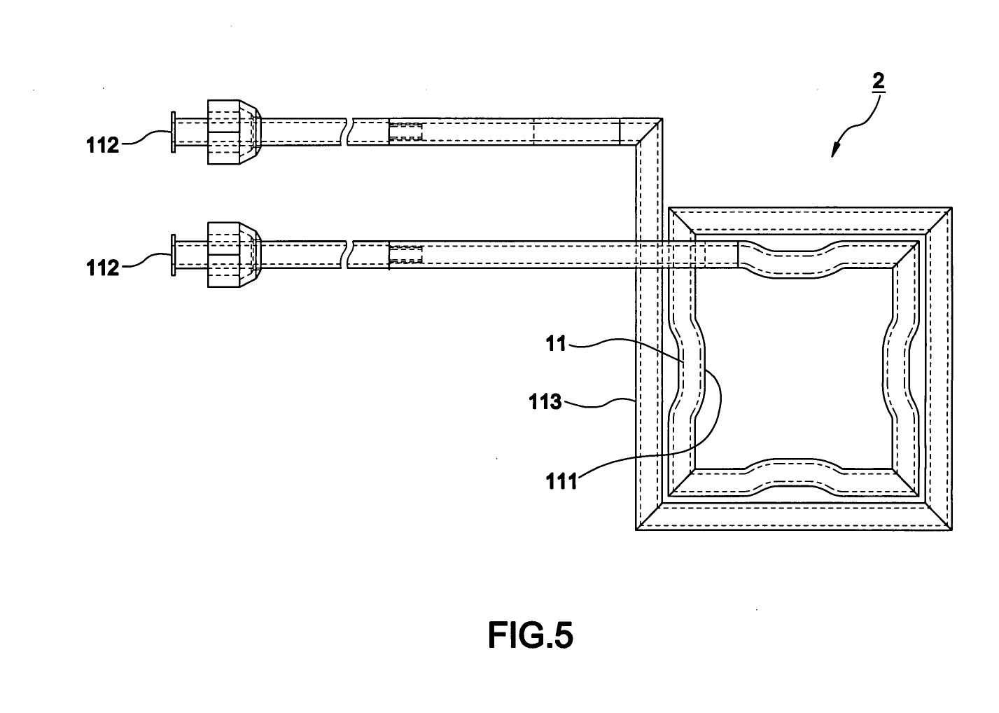

Referring to FIGS. 4-5, a heating coil 2 constructed according to a second preferred embodiment of the present invention is similar to that of the first embodiment, having the following difference. Each of the approach portions 111 has a horizontal length. The horizontal lengths of the opposite approach portions 111 are different from each other.

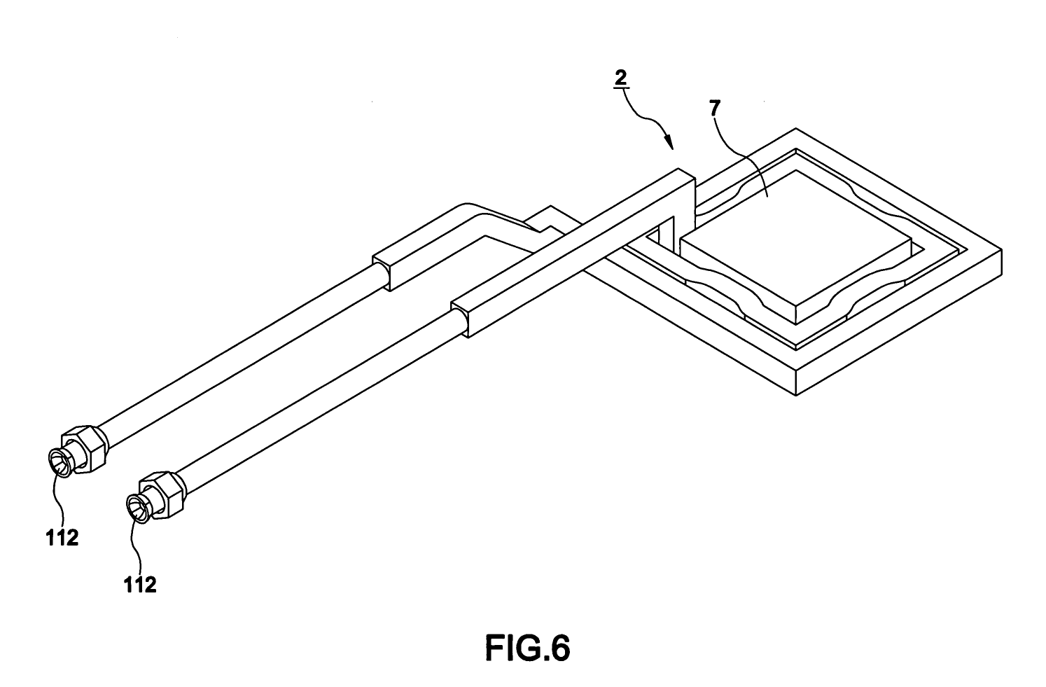

Referring to FIG. 6, the operation of the second embodiment of the present invention is identical to that of the first embodiment, such that no more recitation is necessary.

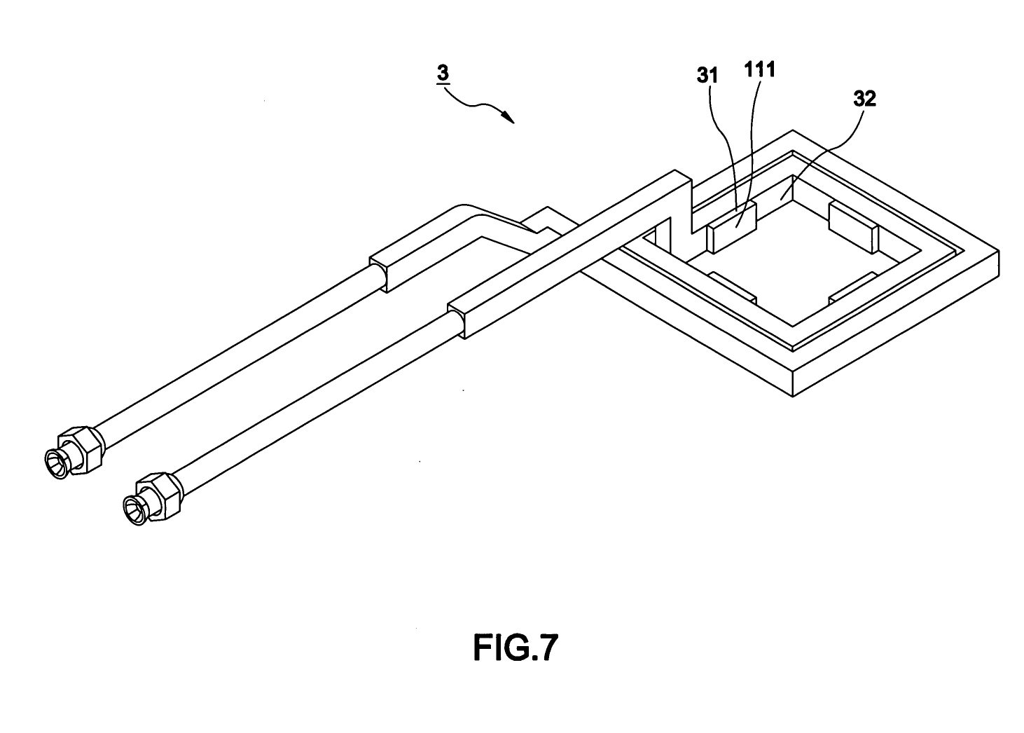

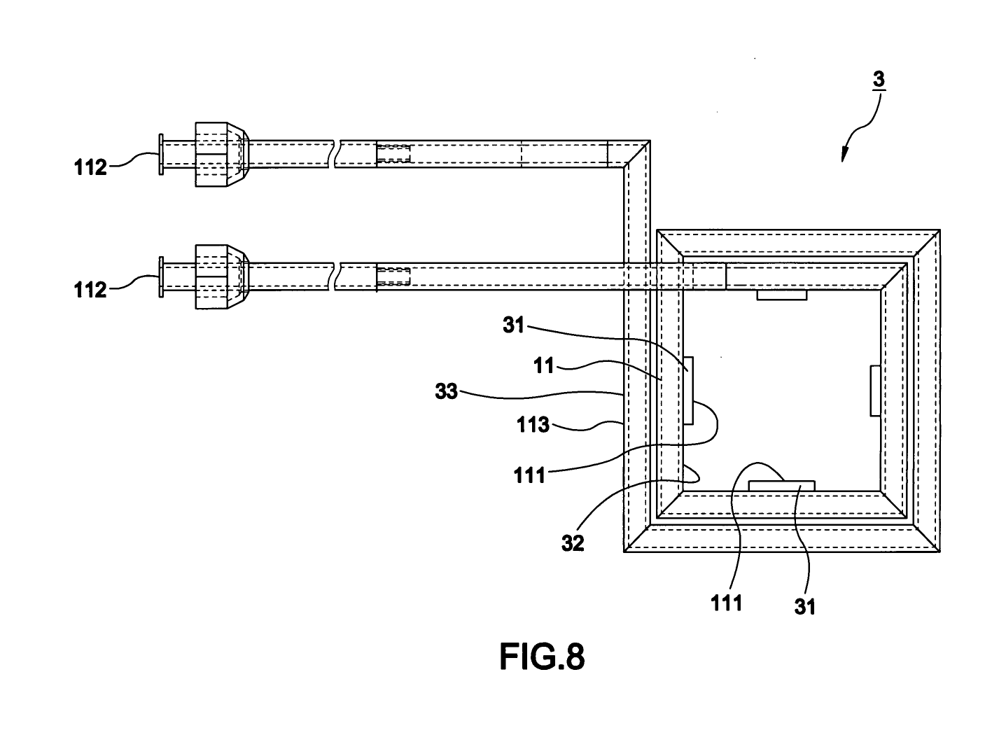

Referring to FIGS. 7-8, a heating coil 3 constructed according to a third preferred embodiment of the present invention is similar to that of the first embodiment, having the following difference. The heating coil 3 includes four convex members 31, each of which is electrically connected with the winding 11. Each of the approach portions 111 is formed on one of the convex members 31. It is to be noted the winding 11 includes an internal side 32 and the convex members 31 are fixed to the internal side 32. The winding 11 further includes a protective cover 23 functioning as that of the first embodiment.

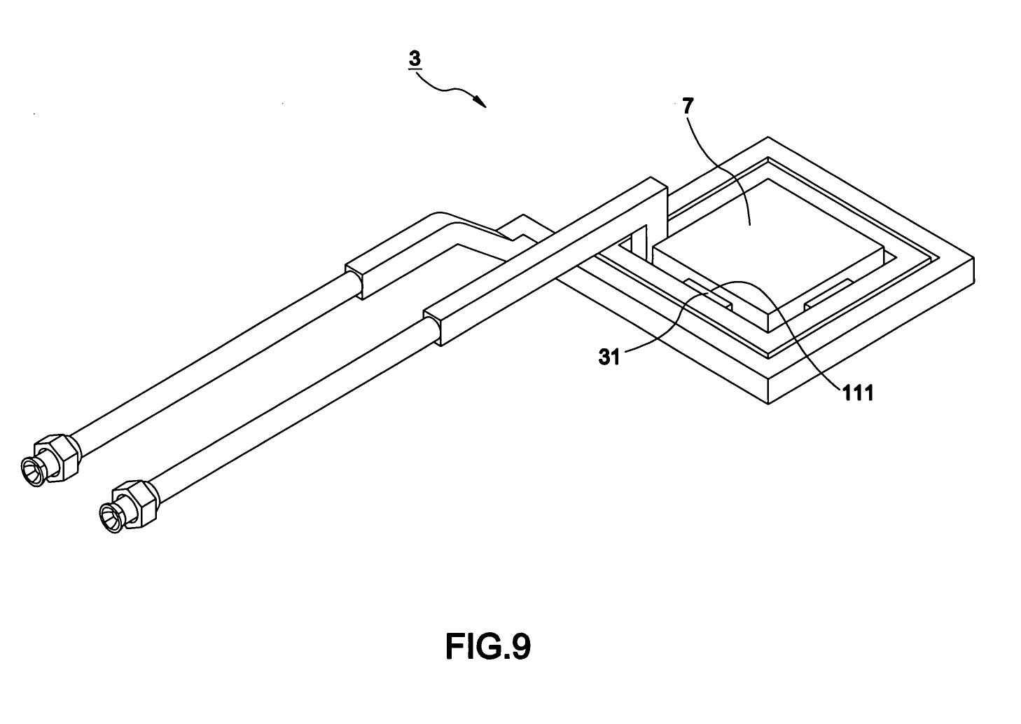

Referring to FIG. 9, the operation of the third embodiment is similar to that of the first embodiment, having the following difference. The power of the high-frequency power source (not shown) in this embodiment is transmitted through the convex members 31 to the approach portions 111 and the heating coil 3 starts to heat the workpiece 7 by induction after electrified.

In conclusion, the heating coil of the present invention can make the overall temperature of the heated workpiece more equable than the prior art.

Although the present invention has been described with respect to specific preferred embodiments thereof, it is in no way limited to the specifics of the illustrated structures but changes and modifications may be made within the scope of the appended claims.

What is claimed is:

1. A heating coil comprising at least one winding having a plurality of approach portions and two electrodes, each of the approach portions being close to a workpiece surrounded by the winding, the two electrodes being formed at two ends of the winding respectively for electric connection with a high-frequency power source.

2. The heating coil as defined in claim 1, wherein the winding is quadrangular.

3. The heating coil as defined in claim 2, wherein each two of the approach portions are opposite to each other.

4. The heating coil as defined in claim 3, wherein each of the approach portions comprises a horizontal length, the horizontal lengths of each opposite approach portions being different from each other.

5. The heating coil as defined in claim 1, wherein the electrodes are parallel to each other.

6. The heating coil as defined in claim 1 further comprising a protective cover encasing the winding.

7. The heating coil as defined in claim 1 further comprising a plurality of convex members, wherein each of the convex members is electrically connected with the winding to become one of the approach portions.

8. The heating coil as defined in claim 7, wherein the winding comprise an internal side and each of the convex members is fixed to the internal side.

9. The heating coil as defined in claim 7 further comprising a protective cover encasing the winding.
